(19) United States
(12) Patent Application Publication
(10) Pub. No.: US 2022/0168958 A1
(43) Pub. Date: Jun. 2, 2022

(54) POWDER REMOVAL PROCESS FOR ADDITIVELY MANUFACTURED ARTICLE

(71) Applicant: INERT CORPORATION, Amesbury, MA (US)

(72) Inventors: Jarod Lawther, Amesbury, MA (US); Brian Cormier, Haverhill, MA (US)

(21) Appl. No.: 17/537,017

(22) Filed: Nov. 29, 2021

Related U.S. Application Data
(60) Provisional application No. 63/120,069, filed on Dec. 1, 2020.

(51) Int. Cl. B29C 64/35; B22F 10/68; B33Y 40/20; B08B 5/02; B08B 15/04; B08B 13/00

(52) U.S. Cl. CPC B29C 64/35; B22F 10/68; B08B 13/00; B08B 5/02; B08B 15/04; B33Y 40/20

(57) ABSTRACT

A system and method for removing residual powder from an additively manufactured object is provided, wherein one or more additively manufactured parts covered by loose residual powder are loaded into a chamber. The residual powder is blown off the surface of the object with one or more streams of high-pressure gas. A vacuum is pulled on the chamber with a vacuum pump to reduce or remove air resistance within the chamber and cause the particles to fall out of suspension, e.g., to the bottom of the chamber or into a collection vessel, under the influence of gravity.

### CROSS REFERENCE TO RELATED APPLICATION

This application claims the priority benefit of U.S. provisional application Ser. No. 63/120,069 filed Dec. 1, 2020. The aforementioned application is incorporated herein by reference in its entirety.

### BACKGROUND

The present development is directed to a method and apparatus for the removal of fine powders from an article and which may advantageously be used for the removal of residual powders from an additively manufactured article.

Additive manufacturing (also known as rapid prototyping and 3D printing) is the process of joining materials to make objects from 3D model data, usually layer upon layer, in contrast to casting or molding processes wherein a liquid or pliable material is poured or otherwise shaped using a mold or matrix of a desired shape, and subtractive manufacturing processes such as milling, machining, turning on a lathe, or other controlled material removal process. Exemplary additive manufacturing processes include stereolithography, fused deposition modeling, selective laser sintering, direct metal laser sintering, selective laser melting, direct metal laser melting, and the like.

In many additive manufacturing techniques, particularly those using fine metal powders, unbonded residual powder remains on the surface of the finished 3D part. These residual metal powers need to be removed from the surface. For example, in some cases an additively manufactured metal part may undergo a subsequent heat treatment step, wherein the presence of residual powder on the surface of the object may alter the geometry of the object.

Removal of residual powder from the surface of an additively manufactured object typically causes the powder particles to become suspended in the air. Due to their small size, the particulates can remain suspended for long periods of time. Down flow air, which comes into the top of a depowdering chamber or enclosure and exits at the bottom, has shown to improve the time for the particles to fall out of suspension; however, there will usually be some unwanted and localized flow patterns that keep the particles from falling. It is also known to use a vacuum hose and blow-off nozzles; however, these methods require a low-pressure system for manual manipulation of the hoses, and still allow large amounts of powder to be suspended.

It would therefore be desirable to provide a process of residual powder removal that that can overcome these problems and others.

The present development provides a new and improved powder removal method and apparatus that can speed up the time of powder removal, operate without constant user input, and have a higher throughput capacity, thus reducing overall cost of producing a component.

### SUMMARY

A system and method for removing residual powder from an additively manufactured object are provided, wherein one or more additively manufactured parts covered by loose residual powder are loaded into a chamber; the residual powder is blown off the surface of the object with one or more streams of high-pressure gas; a vacuum is pulled on the chamber with a vacuum pump to reduce or remove air resistance within the chamber and cause the particles to fall into a collection vessel under the influence of gravity. In some embodiments, while under vacuum, short bursts of high-pressure gas are used to continue to depowder the part. The chamber tilts and rotates to pre-selected orientations, while also going through multiple blow-off cycles. In certain embodiments, the chamber maintains certain angles during blow-off to keep powders flowing into the collection vessel.

In one aspect, a method for depowdering one or more additively manufactured objects includes arranging the one or more additively manufactured objects within an interior of a vacuum chamber, the one or more additively manufactured objects having unbound residual powder on a surface thereof. A portion of the unbound residual powder is caused to separate from the surface of the one or more additively manufactured objects. A vacuum is applied to the vacuum chamber to reduce resistance caused by gas molecules within the interior of the vacuum chamber to facilitate removal of the unbound residual powder.

In a more limited aspect, the step of causing a portion of the unbound residual powder to separate from the surface of the one or more additively manufactured objects comprises one or both of: directing one or more streams of a pressurized gas onto the surface of the one or more additively manufactured objects to blow at least some of the unbound residual powder off from the surface of the one or more additively manufactured objects; and moving the one or more additively manufactured objects to cause at least some of the unbound residual powder to fall off from the surface of the one or more additively manufactured objects.

In another more limited aspect, at least some of the unbound residual powder that is separated from the surface of the one or more additively manufactured objects is in suspension with the gas molecules within the interior of the vacuum chamber and the step of applying a vacuum causes unbound residual powder that is in suspension to fall out of suspension under the influence of gravity.

In another more limited aspect, the vacuum chamber is refilled with a low-pressure gas after the unbound residual powder that is in suspension falls out of suspension.

In another more limited aspect, the low-pressure gas is passed through one or more gas diffusers before it enters the vacuum chamber.

In another more limited aspect, at least some of the unbound residual powder that is separated from the surface of the one or more additively manufactured objects is collected in a collection vessel that is in fluid communication with the interior of the vacuum chamber.

In another more limited aspect, the step of applying a vacuum comprises using a vacuum pump in fluid communication with the interior of the vacuum chamber to remove at least some of the gas molecules from the interior of the vacuum chamber.

In another more limited aspect, the vacuum pump includes a filter assembly for separating unbound residual powder from the gas molecules removed from the interior of the vacuum chamber.

In another more limited aspect, the step of applying a vacuum comprises reducing a pressure in the interior of the vacuum chamber to about 0 mBar to about 40 mBar.

In another more limited aspect, one or more bursts of pressurized gas are applied to the surface of the one or more additively manufactured objects during the step of applying a vacuum.

In another more limited aspect, the vacuum chamber is moved to one or more pre-selected orientations during the step of applying a vacuum.

In another more limited aspect, the step of moving the vacuum chamber to one or more pre-selected orientations comprises one or both of tilting the vacuum chamber and rotating the vacuum chamber.

In another more limited aspect, the one or more pre-selected orientations are orientations configured to allow unbound residual powder to fall into a collection vessel.

In another more limited aspect, the step of moving the vacuum chamber to one or more pre-selected orientations comprises one or both of tilting the vacuum chamber and rotating the vacuum chamber.

In another more limited aspect, the step of arranging the one or more additively manufactured objects within the interior of the vacuum chamber includes clamping the one or more additively manufactured objects to a platform within the interior of the vacuum chamber.

In another aspect, an apparatus for depowdering one or more additively manufactured objects having unbound residual powder on a surface thereof includes a vacuum chamber having an interior for receiving the one or more additively manufactured objects and means for separating a portion of the unbound residual powder from the surface of the one or more additively manufactured objects. A vacuum pump is provided for removing gas molecules from within the interior of the vacuum chamber.

In a more limited aspect, the apparatus further includes a collection vessel for collecting unbound residual powder separated from the surface of the one or more additively manufactured objects.

In another more limited aspect, the means for separating a portion of the unbound residual powder from the surface of the one or more additively manufactured objects comprises a source of pressurized gas in fluid communication with the interior of the vacuum chamber.

In another more limited aspect, the means for separating a portion of the unbound residual powder from the surface of the one or more additively manufactured objects comprises a motion assembly coupled to the vacuum chamber, the motion assembly comprising one or more motors or actuators configured to change a position, orientation, or both of the vacuum chamber.

In another more limited aspect, the apparatus further comprises one or more optical sensors configured to detect a quantity of unbound residual powder suspended in the vacuum chamber.

### BRIEF DESCRIPTION OF THE DRAWINGS

The invention may take form in various components and arrangements of components, and in various steps and arrangements of steps. The drawings are only for purposes of illustrating preferred embodiments and are not to be construed as limiting the invention.

FIG. 1 is an isometric view of a depowdering apparatus in accordance with an exemplary embodiment of the invention.

FIG. 2 is an exemplary motion control system herein.

### DETAILED DESCRIPTION OF THE PREFERRED EMBODIMENTS

Although the present development will be described herein primarily by way of reference to metal powders for additive manufacturing, it will be recognized that the present development can be used for all manner of other powders, including plastic powders and other polymers used in additive manufacturing, as well as in other applications in the chemical, pharmaceutical, and other industries that handle fine powders.

The present development is particularly adapted to applications for the removal of powders having particle sizes on the order of microns.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

All numbers herein are assumed to be modified by the term “about,” unless stated otherwise. The recitation of numerical ranges by endpoints includes all numbers subsumed within that range (e.g., 1 to 5 includes 1, 1.5, 2, 2.75, 3, 3.80, 4, and 5).

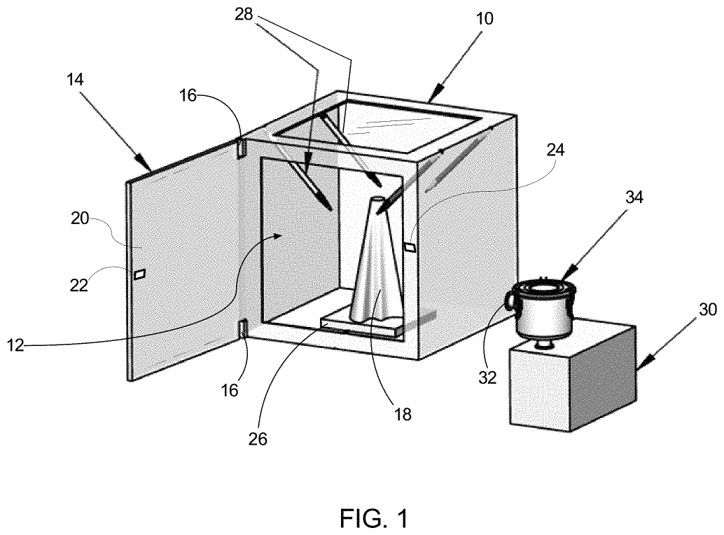

Referring now to the drawing, FIG. 1 illustrates an exemplary powder removal system including a main chamber 10. The main chamber 10 is a vacuum rated chamber having as many feed throughs, fittings, and accessories to safely handle, observe, and depowder a certain range of part sizes. The vacuum chamber 10 includes at least one opening 12 covered by a vacuum door 14 attached to the main chamber via hinges 16. The door 14 may be opened to allow loading and unloading of an object 18 and closed to create a seal against the chamber 10. In certain embodiments, a door seal 20, which may be a peripheral sealing strip or gasket, is disposed between the door 14 and the periphery of the opening 12 on the chamber 10, to provide a sealing engagement therebetween.

In certain embodiments, the chamber door 14 includes a manual or automatic latching mechanism, e.g., a latch 22 engaging a complementary catch mechanism 24 on the chamber 10, to provide a sealing pressure on the door seal 20. In certain embodiments, the door latching mechanism includes a safety interlocking mechanism to prevent operation when the door is in the open position.

The object 18 sits on a platform 26 within the chamber 10. In certain embodiments, the platform 26 has many holes to mount a variety of sizes of objects 18. In certain embodiments, the entire chamber 10 is movable to allow the object 18 to be positioned during the depowdering process to optimize powder removal for the specific size and geometry of the object. In certain embodiments, the chamber 10 is movable in one or more directions for example, an up and down direction, a lateral or side-to-side direction, a forward and back direction, and/or rotation about an axis, e.g., a vertical axis, horizontal axis, or other axis.

In certain embodiments, the chamber 10 can be moved by an operator manually. In certain embodiments, the chamber 10 is movable automatically under programmed control to manipulate the object 18 during the process to optimize powder removal for the specific object 18, e.g., based on the known geometry of the object 18.

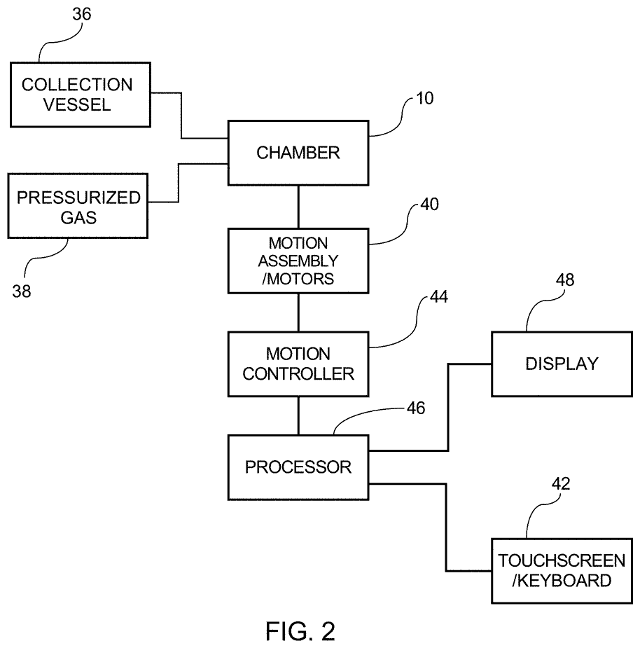

Referring now to the drawing FIG. 2, in certain embodiments, the chamber 10 is moved under the control of a computer-based information handling system which can be implemented with a motion assembly 40, e.g., having one or more motors or actuators, coupled to the chamber 10. In certain embodiments, the motion assembly 40 includes one or more motors or actuators coupled to the chamber 10, wherein the one or more motors or actuators are configured to move the chamber in a plurality of directions, including translation (e.g., up, down, left, right, back, forward) and rotation (e.g., pitch, roll, and yaw). In the preferred embodiments, the motion actuators are preferably electric motors, although alternatively or additionally other types of motion actuators may be used, including mechanical drivers, hydraulic drivers, pneumatic drivers, and the like.

A user interface such as a keypad or touchscreen 42 may be provided to allow an operator user to input a command (e.g., motion pattern, start/stop) to motion control circuitry 44. A microprocessor 46 processes the input commands and sends a signal to effect a motion pattern contained in the instructions to the motion control circuitry 44, which in turn, operates the motion assembly 40 to effect a selected motion. The user interface may also can include a display or other visual indicator (e.g., one or more LEDs) 48 to output a visual indication of the status of the motion assembly 40.

With continued reference to FIG. 1, in conjunction with manipulating chamber 10, the use of at least one gas nozzle 28, which preferably includes a flexible hose portion, can be used to blow air or other gas into tight spaces. For brevity, the present development will be described primarily in reference to preferred embodiments wherein the gas within the chamber and the gas used to blow-off the residual powder is air. However, it will be recognized that any other gas may be used, including for example, nitrogen, argon, or other gas.

A vacuum pump 30 is fluidically coupled to the main chamber 10, e.g., via a gas conduit 32. The vacuum pump 30 pulls the air from the chamber 10. The vacuum applied to the chamber should be sufficiently strong such that it reduces air resistance within the chamber 10 and thereby reduces the amount of time for the powder to settle down and fall out of suspension after blow-off In certain embodiments, the pressure in the chamber interior is reduced to a pressure of between about 0 mBar and about 40 mBar, preferably between about 1 mBar and about 20 mBar, and more preferably <10 mBar.

In addition, during operation, at least a portion of the residual powder is entrained in the air that is removed from the chamber 10 by the vacuum pump 30. One or more particle filters 34, e.g., comprising a filtration medium within a filter housing, is disposed between the chamber 10 and the inlet of the pump 30. The filtration medium is of a type configured to filter the sizes of residual powder particles to be removed from the object during the powder removal process.

In operation, one or more additively manufactured parts 18 covered by loose residual powder are loaded into the chamber 10, which is configured to withstand a vacuum. In certain embodiments, the part 18 is clamped to the platform 26 to allow manual or automated motion to gain access to all sides of the part 18. In certain embodiments, the use of flexible hoses or the like can be directed to optimize powder removal of the specific component. The chamber 10 is sealed shut. In certain embodiments, the door 14 includes a lock or latch mechanism having an interlock comprising one or more switches or sensors to prevent blow-off of powders via the nozzles 28 while the door 14 is in the open position. When the door 14 is in the closed position, a vacuum 30 is applied to the chamber 10 to remove as much oxygen as possible, as well as to reduce or remove the resistance of air or other gas within the chamber 10 and help the particles fall out of suspension faster than with gravity, down flow air stream, or manual vacuum techniques. In certain embodiments, the powder is removed via some combination of motion and high-pressure bursts of air or other gas. Once the residual powder is blown off the part, some of the residual powder will be in suspension in the air within the chamber 10. Vacuum is then pulled on the entire chamber using the pump 30 to allow the powder to fall into a collection vessel 36, which is in fluid communication with the interior of the chamber 10. After the residual powder has fallen out of suspension, the chamber 10 can go through one or more additional blow-off sequences or be prepared for part removal.

As an alternative to, or addition to, the use of viewing ports, one or more cameras may be used to visualize the object 18 when manually manipulating the flexible nozzles 28 and/or moving/manipulating the chamber 10, or for visual inspection of the item 18 after a depowdering cycle to determine whether one or more additional depowdering cycles are required.

In still further embodiments, one or more optical sensors comprising one or more optical emitters and optical receivers may be provided to determine whether multiple cycles of the above vacuum/refill process need to occur for proper powder removal. In operation, the optical sensor determines the quantity or concentration of suspended particles in the chamber by measuring the scattering of light emitted by the emitter as it passes through the chamber 10 after the blow-off step. If it is determined whether the quantity of suspended particles after the blow-off step is above a predetermined or preselected threshold value, additional depowdering cycles may be performed until the quantity of suspended particles after the blow-off step is below the predetermined or preselected threshold value. Once a desired level of depowdering has been achieved, the chamber 10 is refilled with low-pressure gas, e.g., until the gas pressure in the chamber is approximately equal to ambient air pressure. Preferably, the low-pressure gas is passed through one or more diffusers before entering the chamber to prevent the gas from stirring up any residual powder remaining in the chamber and the part is removed.

The invention has been described with reference to the preferred embodiments. Modifications and alterations will occur to others upon a reading and understanding of the preceding detailed description. It is intended that the invention be construed as including all such modifications and alterations insofar as they come within the scope of the appended claims or the equivalents thereof.

What is claimed is:

1. A method for depowdering one or more additively manufactured objects, the method comprising the steps of:
arranging the one or more additively manufactured objects within an interior of a vacuum chamber, the one or more additively manufactured objects having unbound residual powder on a surface thereof;
causing a portion of the unbound residual powder to separate from the surface of the one or more additively manufactured objects; and
applying a vacuum to the vacuum chamber to reduce resistance caused by gas molecules within the interior of the vacuum chamber to facilitate removal of the unbound residual powder.

2. The method of claim 1, wherein the step of causing a portion of the unbound residual powder to separate from the surface of the one or more additively manufactured objects comprises one or both of:
directing one or more streams of a pressurized gas onto the surface of the one or more additively manufactured objects to blow at least some of the unbound residual powder off from the surface of the one or more additively manufactured objects; and
moving the one or more additively manufactured objects to cause at least some of the unbound residual powder to fall off from the surface of the one or more additively manufactured objects.

3. The method of claim 1, wherein at least some of the unbound residual powder that is separated from the surface of the one or more additively manufactured objects is in suspension with the gas molecules within the interior of the vacuum chamber and further wherein the step of applying a vacuum causes unbound residual powder that is in suspension to fall out of suspension under the influence of gravity.

4. The method of claim 3, further comprising:
after the unbound residual powder that is in suspension falls out of suspension, refilling the vacuum chamber with a low-pressure gas.

5. The method of claim 3, wherein the low-pressure gas is passed through one or more gas diffusers before it enters the vacuum chamber.

6. The method of claim 1, further comprising:
collecting at least some of the unbound residual powder that is separated from the surface of the one or more additively manufactured objects in a collection vessel that is in fluid communication with the interior of the vacuum chamber.

7. The method of claim 1, wherein the step of applying a vacuum comprises using a vacuum pump in fluid communication with the interior of the vacuum chamber to remove at least some of the gas molecules from the interior of the vacuum chamber.

8. The method of claim 7, wherein the vacuum pump includes a filter assembly for separating unbound residual powder from the gas molecules removed from the interior of the vacuum chamber.

9. The method of claim 1, wherein the step of applying a vacuum comprises reducing a pressure in the interior of the vacuum chamber to about 1 mBar to about 40 mBar.

10. The method of claim 1, further comprising:
during the step of applying a vacuum, applying one or more bursts of pressurized gas to the surface of the one or more additively manufactured objects.

11. The method of claim 1, further comprising:
during the step of applying a vacuum, moving the vacuum chamber to one or more pre-selected orientations.

12. The method of claim 11, wherein the step of moving the vacuum chamber to one or more pre-selected orientations comprises one or both of tilting the vacuum chamber and rotating the vacuum chamber.

13. The method of claim 11, wherein the one or more pre-selected orientations are orientations that are configured to allow unbound residual powder to fall into a collection vessel.

14. The method of claim 1, wherein the step of moving the vacuum chamber to one or more pre-selected orientations comprises one or both of tilting the vacuum chamber and rotating the vacuum chamber.

15. The method of claim 1, wherein the step of arranging the one or more additively manufactured objects within the interior of the vacuum chamber includes clamping the one or more additively manufactured objects to a platform disposed within the interior of the vacuum chamber.

16. An apparatus for depowdering one or more additively manufactured objects having unbound residual powder on a surface thereof, comprising:
a vacuum chamber having an interior for receiving the one or more additively manufactured objects;
means for separating a portion of the unbound residual powder from the surface of the one or more additively manufactured objects; and
a vacuum pump for removing gas molecules from within the interior of the vacuum chamber.

17. The apparatus of claim 16, further comprising:
a collection vessel for collecting unbound residual powder separated from the surface of the one or more additively manufactured objects.

18. The apparatus of claim 16, wherein the means for separating a portion of the unbound residual powder from the surface of the one or more additively manufactured objects comprises a source of pressurized gas in fluid communication with a nozzle disposed within the interior of the vacuum chamber.

19. The apparatus of claim 16, wherein the means for separating a portion of the unbound residual powder from the surface of the one or more additively manufactured objects comprises a motion assembly coupled to the vacuum chamber, the motion assembly comprising one or more motors or actuators configured to change a position, orientation, or both, of the vacuum chamber.

20. The apparatus of claim 16, further comprising:
one or more optical sensors configured to detect a quantity of unbound residual powder suspended in the vacuum chamber.
